(19) United States
(12) Patent Application Publication
(10) Pub. No.: US 2019/0140392 A1
(43) Pub. Date: May 9, 2019

(54) Quick Self-locking and Self-unlocking Electric Connector

(71) Applicant: Jiusheng Zou, Dongguan (CN)

(72) Inventor: Jiusheng Zou, Dongguan (CN)

(21) Appl. No.: 16/139,008

(22) Filed: Sep. 22, 2018

(30) Foreign Application Priority Data
Nov. 3, 2017 (CN) 201721451782.6

(51) Int. Cl. H01R 13/625; H01R 13/502

(52) U.S. Cl. CPC H01R 13/625; H01R 13/5025

(57) ABSTRACT

A quick self-locking and self-unlocking electrical connector, featuring the female socket and male plug that is used to build the electrical connection with the female socket, the female socket includes the base and the outer shell which is connected to the base with rotatory feature; The outer shell is equipped with a block, the block has the first slope, the male plug is equipped with the locking kit, the locking kit has the second slope to coordinate with the first slope, the first blocking surface formed by laterally bending the second slope and the second blocking surface formed by vertically bending the first blocking surface, the base is equipped with elastic kit, the elastic kit is used to default the outer shell.

### DETAILED DESCRIPTION OF THE INVENTION

FIG. 1, FIG. 2 and FIG. 8 show a quick self-locking and self-unlocking electrical connector, featuring the female socket 1 and male plug 2 that is used to build the electrical connection with the said female socket 1, the said female socket 1 includes the base 3 and the outer shell 4 which is connected to the said base 3 with rotatory feature; The said outer shell 4 is equipped with a block 5, the said block 5 has the first slope 51, the said male plug 2 is equipped with the locking kit 7, the said locking kit 7 has the second slope 21 to coordinate with the first slope 51, the first blocking surface 23 formed by laterally bending the second slope 21 and the second blocking surface 24 formed by vertically bending the first blocking surface 23, the said base 3 is equipped with elastic kit 6, the said elastic kit 6 is used to default the outer shell 4. FIG. 5 shows users push male plug 2 into female socket 1, the second slop 21 of male plug 2 touches the first slop 51 of female socket 1. This causes the outer shell 4 of female socket 1 to rotate according to base 3, outer shell 4 rotates to compress the elastics kit 6. FIG. 6 shows that when male plug 2 fully inserts into female socket 1, the second slop 21 disengages the first slop 51, and elastic kit 6 retrieves and causes outer shell 4 to rotate around base 3, the block 5 of outer shell 4 then gets stuck into male plug 2, so the first blocking surface 23 prevents block 5 from moving downwards, the second blocking surface prevents the block 5 from moving to the right side, at the same time elastic kit 6 prevents the block 5 from moving to the left, now the male plug is pushed and quickly locked into the female socket. FIG. 7 shows to separate male plug 2 from female socket 1: twist outer shell 4 to push back elastic kit 6, block 5 follows outer shell 4's rotation to exit the locking kit 7, the first blocking surface 23 no longer stops the block, so the male plug 2 can be pulled to unlock quickly. This electrical connector not only offers reliable connection, but also offers quick and convenience connecting and disconnecting of female socket 1 and male plug 2 in a practical way.

FIG. 3 and FIG. 6 show the outer shell 4 is equipped with slide 8, the base 3 is equipped with the notch 31 containing the slide 8 and the elastic kit 6, the slide 8 slides in the notch 31, one side of the elastic kit 6 is fixed on the inner side of the notch 31, the other side is used to against the slide 8. The elastic kit 6 causes outer shell 4 to rotate by pushing against slider 8. On one hand notch 31 limits the movement of elastic kit 6 to prevent elastic kit 6's movement from failed drive, on the other hand it blocks slider 8 to make outer shell 4 rotate freely but at the same time prevent it from falling off the base 3.

FIG. 3 shows the base 3 has the first projecting part 32 and the second projecting part 33, the notch 31 is placed between the first projecting part 32 and the second projecting part 33, the first projecting part 32 has the dent 321 which allows the slide 8 to enter and exit the notch 31. After the slider 8 exits the notch 31 through the dent 321, the first projecting part 32 and the second projecting part 33 no longer block the block 8, so outer shell 4 can be removed out of base 3 to be repaired and maintained.

FIG. 3 shows the notch 31 has an elastic limiter 9, the end of the elastic limiter 9 that is away from the dent 321 is equipped with the third slope 91, the end that is close to the dent 321 is equipped with the forth slope 92 that has opposite tilting direction as the third slope 91. The third slope 91 is used to prevent the slider 8 from exit from the notch 31 via the dent 321, the forth slope 92 is used to help the slide 8 enter the notch 31. The elastic limiter 9 is made of rubber and can have microscopic elastic shape change. When the slide 8 is positioned inside the notch 31, the third slope 91 blocks the slide 8, to prevent the slide 8 from exiting the dent 321 easily. When user twists the outer shell 4 to push the slide 8 to move towards the dent 321, the third slope 91 and the slide 8 form decent amount of radial force to make the elastic limiter 9 have a small amount of shrinkage in the radial direction, so the slide 8 will have enough space to move past the limiter and exit from the dent 321. When in need to put the slide 8 into the notch 31, twist the outer shell 4 to move the slide 8 away from the dent 321, the forth slope 92 and the slide 8 form decent amount of radial force to make the elastic limiter 9 to have a small amount of shrinkage in the radial direction, so the slide 8 will have enough space to pass the limiter and enter the notch 31. Slide 8 needs to receive a decent amount of force to exit the notch 31, which guarantees the outer shell 4 will not fall from the base 3 in day to day use. FIGS. 2, 4, 7 and 8 show the block 5 is equipped with the sixth slope 52, which tilts the opposite direction to the first slope 51. The male plug 2 is equipped with the fifth slope 22 that is in coordination with the sixth slope 52. When user is in need of pulling out the male plug 2, twist the outer shell 4 so the fifth slope 22 of the block 5 is pushed against the sixth slope 52 of the male plug 2, male plug 2 receives the axial force and automatically pushes out the base 1 upwards to make dissemble more convenient.

FIGS. 1 and 2 show the outer surface of the outer shell 4 is equipped with anti-sliding dent 41 to effectively prevent the outer shell 4 from sliding when user twist it.

FIG. 1 shows the outer shell 4 is equipped with unlocking indicator 42 to effectively remind user of the rotating direction to unlock.

### BRIEF DESCRIPTION OF DRAWINGS

FIG. 1 is the three-dimensional structure view for this new electrical connector.

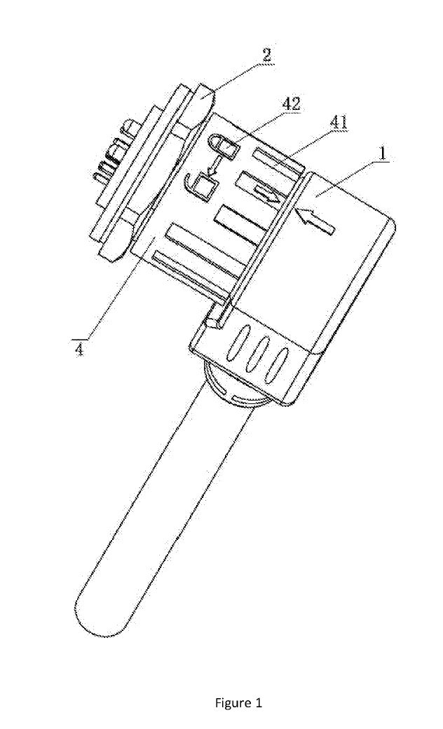

FIG. 2 is the exploded view of this new practical electrical connector.

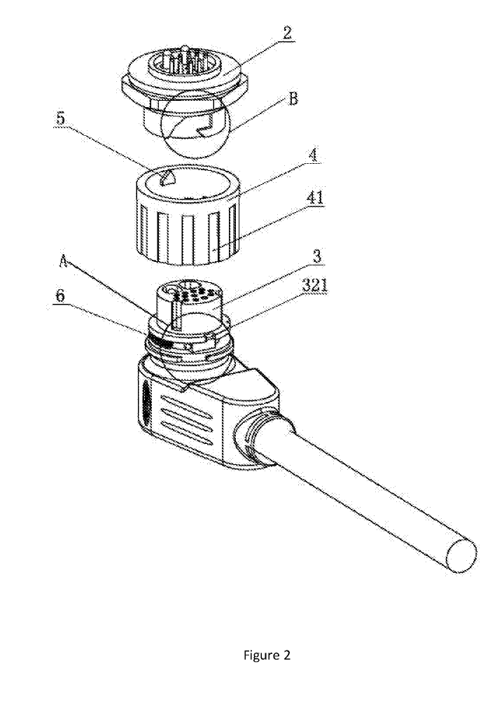

FIG. 3 is the enlarged view of the A section in FIG. 2.

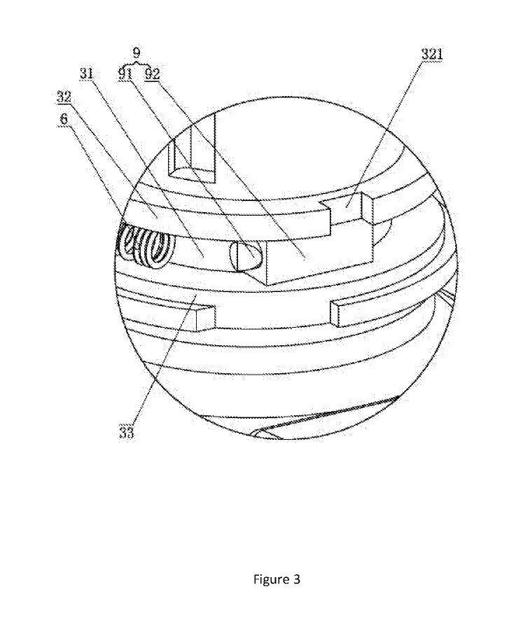

FIG. 4 is the three-dimensional structure view of the outer shell.

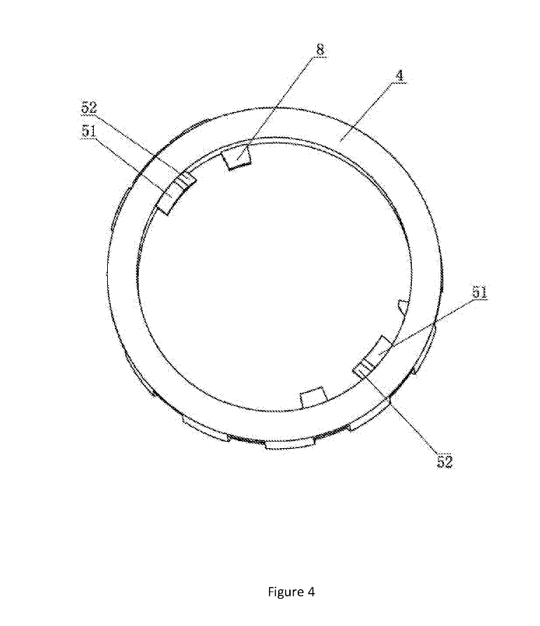

FIG. 5 is the view when male plug inserts into the female socket.

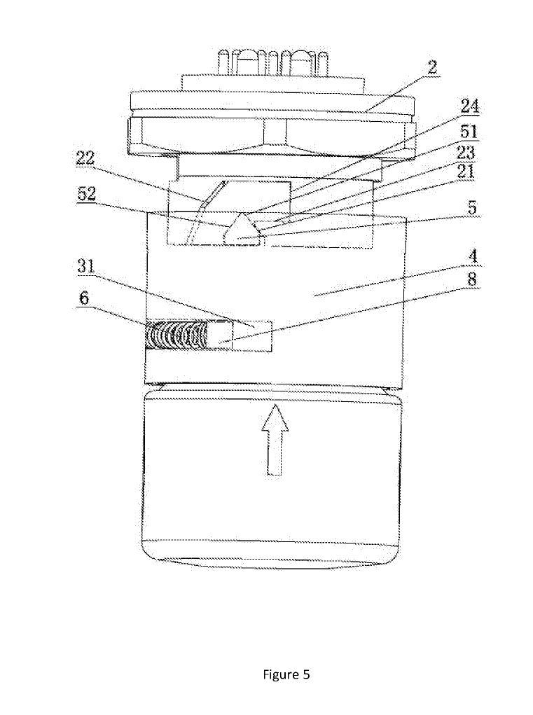

FIG. 6 is the view when the female socket locks the male plug.

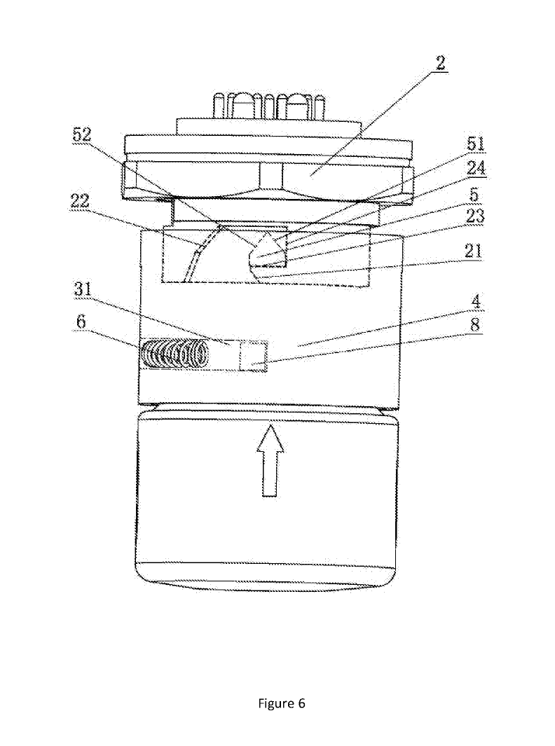

FIG. 7 is the view of the electrical connector when unlocked.

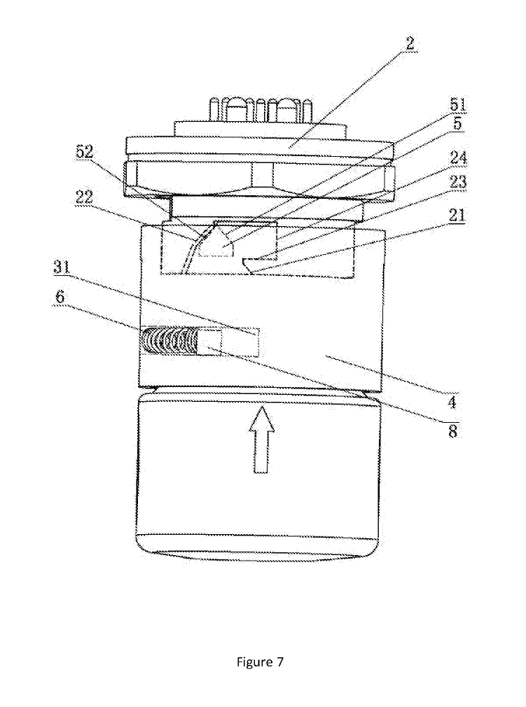

FIG. 8 is the enlarged view of the B section in FIG. 2.

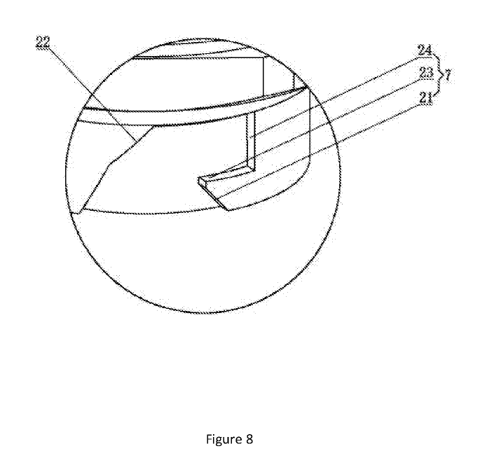

### BACKGROUND OF THE INVENTION

Nowadays the male plug and the female socket of the electrical connectors usually connect each other by pushing in or screw thread. Pushing in is quick and convenient, but it is often loose between the male plug and female socket, causing a bad electrical connection. Screw thread can grantee a good electrical connection between the male plug and the female socket, but it is inconvenience for users to assemble and dismantle the connection by rotating many times.

### BRIEF SUMMARY OF THE INVENTION

This new quick self-lock and unlock electrical connector provides solution to the current electrical connectivity issue by providing a reliable electrical connection and easy to use feature.

This new electrical connector has applied the following technologies: a quick self-locking and self-unlocking electrical connector, including the female socket and the male plug that is used to build the electrical connection with the said female socket, the said female socket including the base and outer shell which is connected to the said base with rotatory feature; the said outer shell is equipped with a block, the said block has the first slope, the said male plug is equipped with a locking kit, the said locking kit has the second slope to coordinate with the first slope, the first blocking surface formed by laterally bending the second slope, and the second blocking surface formed by vertically bending the first blocking surface, the said base is equipped with elastic kit, the said elastic kit is used to default the outer shell. As a priority, the said outer shell is equipped with a slide, the said base is equipped with the notch containing the said slide and the elastic kit, the said slide slides in the notch, one side of the said elastic kit is fixed on the inner side of the notch, the other side is used to against the said slide.

As a priority, the said base has the first projecting part and the second projecting part, the said notch is placed between the first projecting part and the second projecting part, the said first projecting part has the dent which allows the said slide to enter and exit the said notch.

As a priority, the said notch has an elastic limiter, the end of the said elastic limiter that is away from the said dent is equipped with the third slope, The other end of the said elastic limiter that is close to the said dent is equipped with the forth slope, which tilts the opposite direction to the said third slope.

As a priority, the said block is equipped with the sixth slope, which tilts the opposite direction to the said first slope. The said male plug is equipped with the fifth slope that is in coordination with the said sixth slope.

As a priority, the outer surface of the said outer shell is equipped with anti-sliding dent.

As a priority, the said outer shell is equipped with unlocking indicator.

The beneficial effects from this new electrical connector: when the male plug is plugged into the female socket, the female socket automatically rotates to jam the block on the female socket with the locking kit on the male plug. This achieves the quick self-lock effect; user unplugs the male plug by rotating the female socket until the locking kit on the male plug is no longer stuck by the block on the female socket. This achieves the quick unlock effect. This new electrical connector not only provides reliable electrical connections, but also features fast, convenient connecting and disconnecting of the male plug and the female socket. It is highly practical.

1: A quick self-lock and unlock electrical connector, featuring the female socket and male plug that is used to build the electrical connection with the said female socket, the said female socket including the base and the outer shell which is connected to the said base with rotatory feature;
The said outer shell is equipped with a block, the said block has the first slope, the said male plug is equipped with the locking kit, the said locking kit has the second slope to coordinate with the first slope, the first blocking surface formed by laterally bending the second slope and the second blocking surface formed by vertically bending the first blocking surface, the said base is equipped with elastic kit, the said elastic kit is used to default the outer shell.

2. The said quick self-lock and unlock electrical connector according to claim 1, has the following features: the said outer shell is equipped with slide, the said base is equipped with the notch containing the said slide and the elastic kit, the said slide slides in the notch, one side of the said elastic kit is fixed on the inner side of the notch, the other side is used to against the said slide.

3. The said quick self-lock and unlock electrical connector according to claim 2, has the following features: the said base has the first projecting part and the second projecting part, the said notch is placed between the first projecting part and the second projecting part, the said first projecting part has the dent which allows the said slide to enter and exit the said notch.

4. The said quick self-lock and unlock electrical connector according to claim 3, has the following features: the said notch has an elastic limiter, the end of the said elastic limiter that is away from the said dent is equipped with the third slope. The other end of the said elastic limiter that is close to the said dent is equipped with the forth slope, which tilts the opposite direction to the said third slope.

5. The said quick self-lock and unlock electrical connector according to claim 1, has the following features: the said block is equipped with the sixth slope, which tilts the opposite direction to the said first slope. The said male plug is equipped with the fifth slope that is in coordination with the said sixth slope.

6: The said quick self-lock and unlock electrical connector according to claim 1, has the following feature: the outer surface of the said outer shell is equipped with anti-sliding dent.

7: The said quick self-lock and unlock electrical connector according to claim 1, has the following feature: the said outer shell is equipped with unlocking indicator.
